(19) United States
(12) Patent Application Publication
(10) Pub. No.: US 2013/0085763 A1
(43) Pub. Date: Apr. 4, 2013

(54) CODEC DEVICES AND OPERATING AND DRIVING METHOD THEREOF

(71) Applicants: Tzu-Ching PENG, New Taipei City (TW); Wei-Tung LIAO, New Taipei City (TW); Ping-Hsien LU, New Taipei City (TW); Hui-Lin WANG, Beijing (CN)

(72) Inventors: Tzu-Ching PENG, New Taipei City (TW); Wei-Tung LIAO, New Taipei City (TW); Ping-Hsien LU, New Taipei City (TW); Hui-Lin WANG, Beijing (CN)

(73) Assignee: VIA TECHNOLOGIES, INC., New Taipei City (TW)

(21) Appl. No.: 13/603,346

(22) Filed: Sep. 4, 2012

(30) Foreign Application Priority Data
Oct. 3, 2011 (TW) 100135715

(51) Int. Cl. G10L 19/00

(52) U.S. Cl. 704/500; 704/E19.001

(57) ABSTRACT

The present application discloses coding and decoding (CODEC) devices and operating and driving methods thereof. The CODEC device includes a first interface compatible with High Definition Audio (HDA) specification, a second interface compatible with Musical Instrument Digital Interface (MIDI) specification, and a converter. The converter is configured to convert a first MIDI command received from the first interface and output a corresponding first converted MIDI command via the second interface, and to convert a second MIDI command received from the second interface and output a corresponding second converted MIDI command via the first interface.

### CROSS REFERENCE TO RELATED APPLICATIONS

This Application claims priority of Taiwan Patent Application No. 100135715, filed on Oct. 3, 2011, the contents of which are incorporated herein by reference.

### BACKGROUND OF THE INVENTION

1. Field of the Invention

The disclosure relates generally to a Musical Instrument Digital Interface (MIDI) CODEC device, and more particularly relates to a CODEC device having a High Definition Audio (HDA) interface.

2. Description of the Related Art

Following the introduction of Intel's High Definition Audio (HDA) Specification Rev 1.0, the HDA interface has gradually gained popularity among PC users. The HDA architecture, defined by the Intel specification, attempts to meet the needs for high-quality audio in PCs. This architecture defines the delivery of high-fidelity audio content from a PC's memory to one or more audio coding and decoding (CODEC) devices, using a HDA controller that performs direct memory access (DMA) transfer of audio data over a HDA bus or a HDA link. The audio data delivered over the HDA bus is received, processed, and outputted by the various components of the CODEC devices.

Nowadays, most host systems use a HDA interface to perform the inputting/outputting of audio signals, and the HDA interface is applied in most computers as an industry standard. Therefore, present CODEC interfaces all follow the standard of the HDA specification in order to connect to a HDA controller.

However, the conventional HDA controller and CODEC device are limited to the standard HDA specification protocol for data transmission, and it does not support MIDI data or signal transmissions. Moreover, the inputting of MIDI data can be transmitted only via the I/O port, and the operating speed of the I/O port is slow. Accordingly, the MIDI I/O port is not included in most host systems. Thus, it is very difficult to implement MIDI input/output on computer host systems having HDA controllers.

In summary, a CODEC device having a HDA interface is required, in order to use an industrial standard HDA interface to connect to peripherals with a MIDI, such as keyboards or voice synthesizers.

### BRIEF SUMMARY OF THE INVENTION

An embodiment of a coding and decoding (CODEC) device comprises a first interface compatible with a High Definition Audio (HDA) specification, a second interface compatible with a Musical Instrument Digital Interface (MIDI) specification, and a converter. The converter is configured to convert a first MIDI command received from the first interface and output a corresponding first converted MIDI command via the second interface, and to convert a second MIDI command received from the second interface and output a corresponding second converted MIDI command via the first interface.

An embodiment of a method for a CODEC device is provided. The method comprises receiving a first MIDI command from a first interface, wherein the first interface is compatible with the HDA specification. The first MIDI command is converted. Subsequently, a corresponding first converted MIDI command is outputted via a second interface to a MIDI device, wherein the second interface is compatible with a MIDI specification.

An embodiment of another method for a CODEC device is provided. The method comprises receiving a second MIDI command from a second interface, wherein the second interface is compatible with a MIDI specification. The second MIDI command is converted. Subsequently, a corresponding second converted MIDI command is outputted via a first interface, wherein the first interface is compatible with a HDA specification.

### BRIEF DESCRIPTION OF DRAWINGS

The invention will become more fully understood by referring to the following detailed description with reference to the accompanying drawings, wherein:

FIG. 1A is a schematic diagram illustrating an embodiment of a coding and decoding (CODEC) device;

FIG. 1B is a schematic diagram illustrating the structure of the command and stream format in the HDA specification;

FIG. 2 is a flowchart of an embodiment of a MIDI output method for the CODEC device shown in FIG. 1A;

FIG. 3 is a flowchart of an embodiment of a MIDI input method for the CODEC device shown in FIG. 1A;

FIG. 4 is a is a flowchart of an embodiment of a driving method applied to the driver of the computer device shown in FIG. 1A; and

FIGS. 5A and 5B are flowcharts of embodiments of a driving method applied to the driver of the computer device shown in FIG. 1A.

### DETAILED DESCRIPTION OF THE INVENTION

The making and using of the embodiments of the present invention are discussed in detail below. It should be appreciated, however, that the embodiments provide many applicable inventive concepts that can be embodied in a wide variety of specific contexts. The specific embodiments discussed are merely illustrative of specific ways to make and use the invention, and do not limit the scope of the invention.

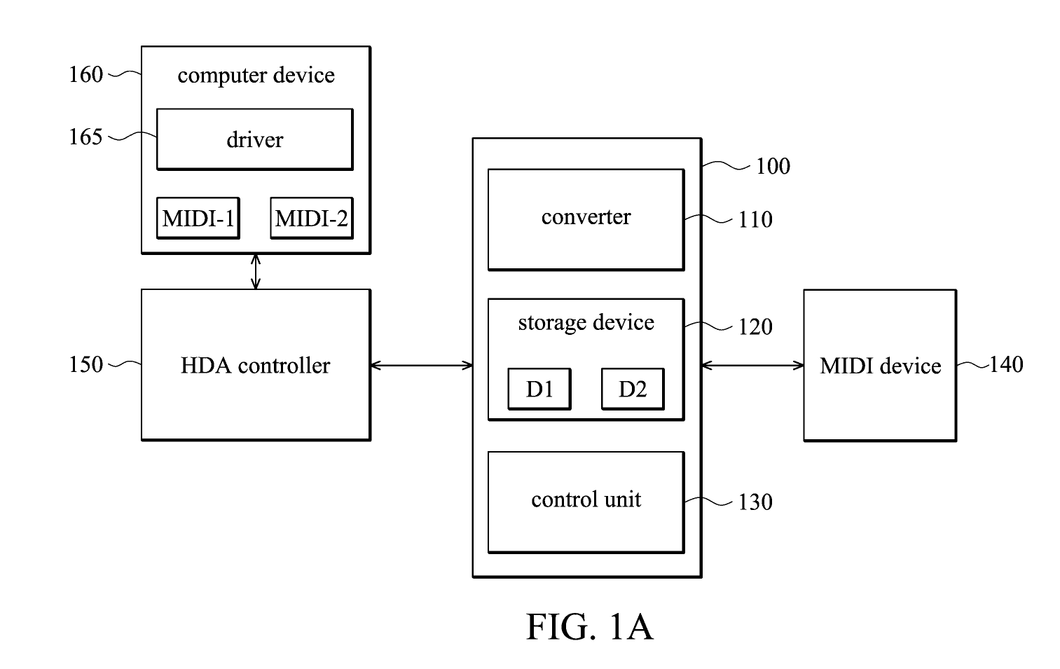

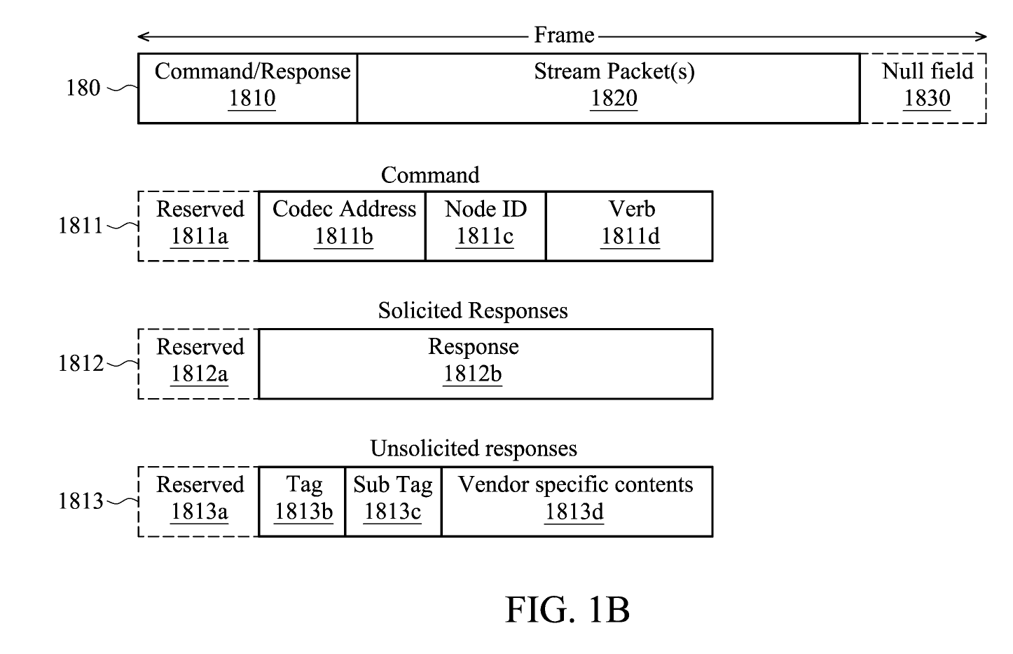

FIG. 1A is a schematic diagram illustrating an embodiment of a MIDI coding and decoding (referred to as CODEC hereafter) device 100 for a High Definition Audio (referred to as HDA hereafter) controller 150 coupled to a computer device, wherein the CODEC device 100 comprises a converter 110, a storage device 120, and a control unit 130. The MIDI CODEC device 100 has coding and decoding functions of High Definition Audio (HDA), which will not be described in detail herein.

Due to the data transmission architecture of the conventional HDA controller having a fixed transmission format protocol, and data or signal transmission of the Musical Instrument Digital Interface (referred to as MIDI hereafter) not being supported by the conventional HDA controller, the present invention utilizes the converter 110 to convert the data format between a MIDI device and a HDA controller. Thus, when the MIDI device 140 couples to the MIDI CODEC device 100 via a MIDI port, the converter 110 converts a HDA data D1 received from the HDA controller 150 into a MIDI output signal. On the other hand, the converter 110 may also convert a MIDI input signal received from the MIDI device 140 into a HDA data D2, so that the communication between a computer device and MIDI device is established by the data transmission architecture of the HDA controller 150. It should be noted that the HDA controller 150 can recognize the formats of HDA data D1 and HDA data D2. Furthermore, due to the MIDI input signal and the MIDI output signal being in MIDI formats, by the conversion of the converter 110, when the MIDI device 140 receives the MIDI output signal, the MIDI device 140 can output the content of the HDA data D1 accordingly. The HDA data D1 is converted from MIDI data MIDI-1 by the driver 165 in the computer device 160 which corresponds to the CODEC device 100. On the other hand, the HDA data D2 can be transmitted to the computer device 160 via the HDA controller 150, and be converted to MIDI data MIDI-2 which has a file format of a MIDI application program executed by a computer. Therefore, the content or command of the MIDI input signal can be recognized by the computer device 160.

The CODEC device 100 comprises a storage device 120 configured to store the HDA data D1 and the HDA data D2, and the outputting and inputting of the stored data in the storage device 120 are controlled and managed by the control unit 130. The storage device 120 may be registers such as vender specific registers. For example, when the storage device 120 receives the HDA data D2 converted by the converter 110, the control unit 130 generates an unsolicited response signal and transmits the unsolicited response signal to the driver 165 of the computer device 160 via the HDA controller 150. When the computer device 160 receives the unsolicited response signal, the driver 165 of the computer device 160 transmits a corresponding command to the HDA controller 150, and then the computer device 160 will obtain the HDA data D2 in the storage device 120 via the HDA controller 150.

Also, it should be noted that the HDA architecture has two main transmission formats as shown in FIG. 1B, which are the command format and stream format. In the HDA specification, each input or output link transmits a series of frames 180 which occur at a fixed rate. Each frame contains command/response information 1810, followed by stream packets 1820; unused space in the frame, if any, is filled with nulls 1830. The HDA interface transmits audio data according to the stream format, and the stream format is preset to have a fixed data transmission rate since audio data are mostly transmitted continuously, such as for an earphone output or microphone input. The command format is used for setting the CODEC device. Since commands are only transmitted when settings are to be made, the command format has a variable data transmission rate, such as for setting the audio bit rate, sound channel number, or audio volume of the earphone output. FIG. 1B shows the command format 1811, solicited response format 1812, and the unsolicited response format 1813 of the command/response field 1810. Each of the formats may comprise certain reserved bits such as 1181a, 1182a, and 1183a. Commands 1811 contain a CODEC address 1811b which is assigned at initialization time and identifies the target CODEC, together with a node ID 1811c that identifies the target node within the CODEC. The verbs 1811d vary in format and may comprise identifiers and payloads. Solicited Responses 1812 contain a response 1812b returned from CODECs in response to a command verb. Unsolicited responses 1813 are sent by the CODEC independently of any software request. The tag field 1813b is used by software to distinguish what CODEC subunit generated the unsolicited response. The sub tag field 1813c is also used by software to distinguish what widget subunit generated the unsolicited response (i.e. presence detect, content protection, etc.). The vendor specific contents 1813d can be used to provide extra contextual information to software regarding the event that generated the unsolicited response.

The format of the MIDI data is not supported by data transmission architecture of the HDA controller 150, and the format of the MIDI data has an unfixed transmission bit rate. Therefore, one embodiment of the present invention is to perform MIDI data communication via the HDA controller based on the transmission of the command format of the HDA specification. As a result, the HDA data D1 and the HDA data D2 of this embodiment are in the command format. When MIDI data is transmitted in the command/response field 1810 in a frame, the stream field 1820 of the frame may contain other data or nulls.

In an embodiment, the computer device 160 can be a host system utilizing an x86 or x64 instruction set, such as C7 or Nano processor and chip sets produced by VIA Technologies, Inc. In another embodiment, the computer device 160 can be a System on Chip (SoC) utilizing reduced instruction set computing, such as a Single-Chip System utilizing Advanced RISC Machine (ARM) or Microprocessor without an Interlocked Pipeline Stages (MIPS) instruction set. The computer 160 can couple to the HDA controller 150 via a standard interface such as Peripheral Component Interconnect (PCI) or PCI express.

For example, the operation system executed by the computer 160 can be a Microsoft Windows, Apple Mac OS, Unix, Symbian, Windows Phone, Android, or iOS system. Generally speaking, the driver 165 is executed by the operation system in order to drive the CODEC device 100. In an embodiment, the driver 165 provides two service endpoints for the operation system, wherein one service endpoint is for the HDA, and the other one is for the MIDI. In another embodiment, the CODEC device 100 can be driven by two independent drivers, wherein one driver provides a service endpoint for HDA, and the other one provides a service endpoint for MIDI. The application program executed by the operation system can drive the CODEC device 100 to use HDA and MIDI functions.

According to the definition in the specification, the HDA controller 150 has a register for temporarily storing the commands to be outputted to the CODEC device 100 and the responses from the CODEC device 100.

When a related application program transmits a MIDI command (ex. the MIDI data MIDI-1) via the operation system to the MIDI service endpoint provided by the driver 165, the driver 165 will pack the MIDI data MIDI-1 into a command compatible with the HDA specification and output the command to the register of the HDA controller 150. Then, the HDA controller 150 transmits the HDA format command to the CODEC device 100. After the converter 110 receives the command, the converter 110 unpacks the MIDI data MIDI-1 contained in the command, and stores the MIDI data MIDI-1 as data D1 into the storage device 120. And then, the CODEC 100 transmits the MIDI data MIDI-1 to the MIDI device 140 via a MIDI.

On the other hand, when the MIDI device 140 transmits MIDI data MIDI-2 command to the CODEC 100 via a MIDI, the MIDI data MIDI-2 will be stored in the storage device 120 as data D2. Accordingly, the control unit 130 generates an unsolicited response signal with a special tag, indicating that a MIDI data MIDI-2 command has been stored in the CODEC device 100. And then, the HDA controller 150 transmits the unsolicited response signal to the driver 165. In one embodiment, the special tag to indicate a MIDI data is stored in the CODEC device may be contained in the tag field 1813b or the sub tag field 1813c or the combination of the two.

In an embodiment, when the driver 165 receives the unsolicited response signal, the driver 165 is aware that the MIDI device 140 has transmitted a command into the CODEC device 100 according to the special tag. The driver 165 will generate another command for reading the data D2 from the storage device 120 of the CODEC device 100. When the CODEC device 100 returns the data D2 from the storage device 120 to the driver 165, the driver 165 will transmit the MIDI data MIDI-2 to the related application program via the MIDI service endpoint.

Generally speaking, the transmission rate of a MIDI is much lower than the transmission rate of an HDA interface. Therefore, the control unit 130 of the CODEC device 100 and the driver 165 must manage the transmission traffic. When the MIDI data in a command format transmitted by the HDA interface is too large, the controller 130 will detect that the available space of the storage device 120 is not enough. Therefore, the controller 130 will notify the driver 165 to suspend the transmission of the MIDI data via the HDA interface. The controller 130 will notify the driver 165 to continue the transmission of MIDI data after the converter 110 gradually transmits the MIDI data in the storage device 120 to the MIDI device 140.

On the other hand, when the CODEC device 100 receives the MIDI data from the MIDI device 140, the unsolicited response signal can be transmitted to the driver 165 after the amount of the MIDI data stored in the storage device 120 reaches a predetermined amount. Therefore, the processing efficiency of the computer device 160 increases because there is no need to transmit the unsolicited response signal to the driver 165 each time when a MIDI data is received.

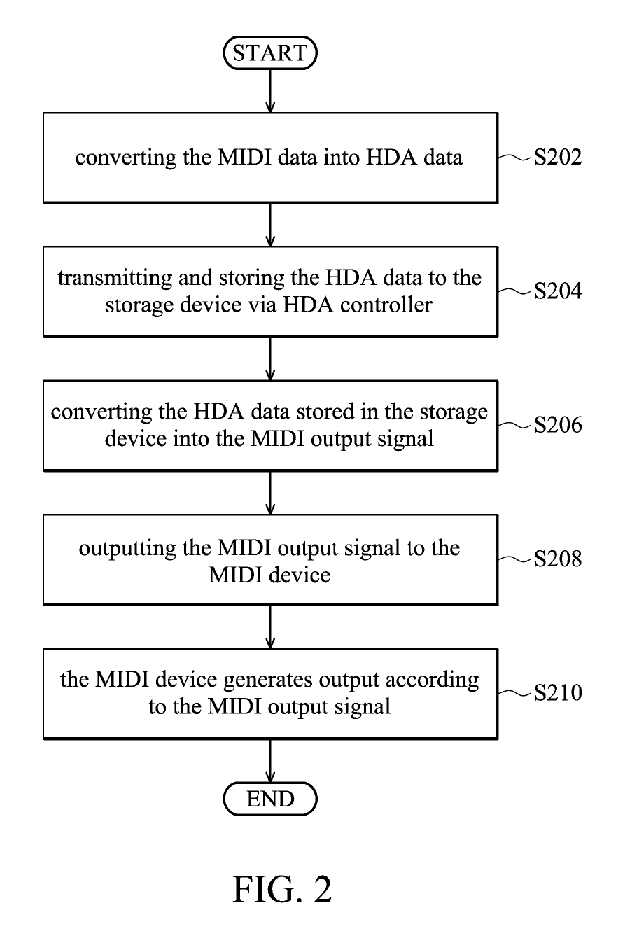

FIG. 2 is a flowchart of an embodiment of a MIDI output method for the MIDI device 100 shown in FIG. 1A. In Step S202, the computer device 160 uses the driver 165 to convert a user instruction or MIDI data MIDI-1 of a MIDI application program into HDA data D1. In Step S204, the HDA data D1 is transmitted to the storage device 120 of the MIDI CODEC device 100 via the HDA controller 150. In Step S206, the converter 110 converts the HDA data stored in the storage device 120 into a MIDI output signal. In Step S208, the converter 110 outputs the MIDI output signal to the MIDI device 140. Finally, in step S210, the MIDI device 140 generates an output corresponding to the content of the MIDI data MIDI-1 according to the MIDI output signal. For example, if the content of the MIDI data MIDI-1 is to produce the note “Do”, the MIDI device 140 will play the note “Do”. It should be noted that the content of the MIDI data MIDI-1 may include a variety of durations, frequencies, and tones of sounds, which may be similarly carried out by the process described above.

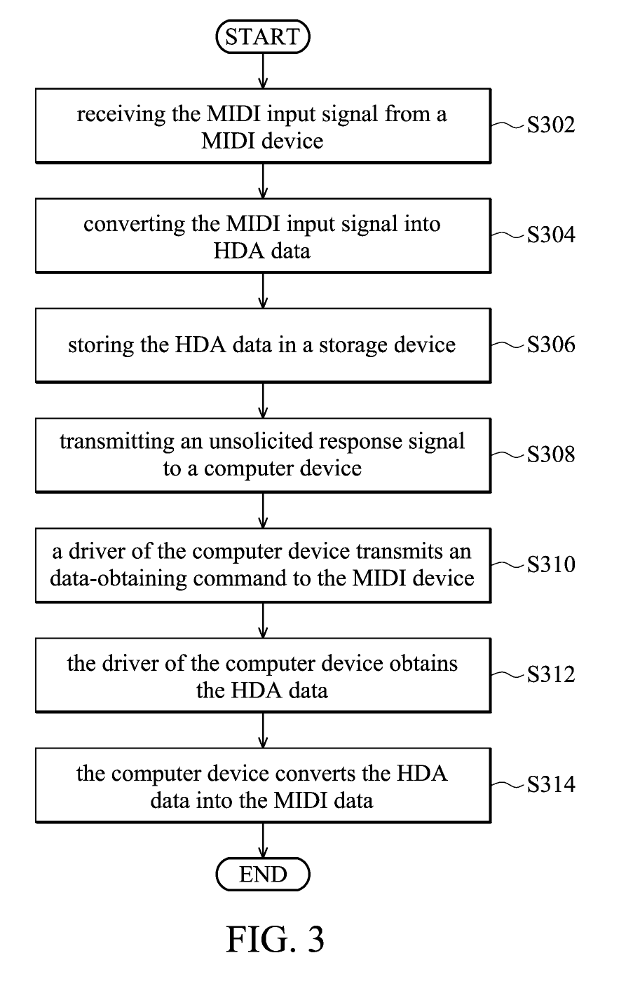

FIG. 3 is a flowchart of an embodiment of a MIDI input method for the MIDI device 100 shown in FIG. 1A. In Step S302, the converter 110 receives the MIDI input signal from the external MIDI device 140. In Step S304, the converter 110 converts the MIDI input signal into the HDA data D2, and stores the HDA data D2 in the storage device 120 in Step S306. In Step S308, the control unit 130 transmits the unsolicited response signal to the computer device 160 via the HDA controller 150, in order to notify the driver 165 that the MIDI device 140 has inputted a command. In Step S310, the driver 165 of the computer device 160 transmits a data-obtaining command to the external MIDI device 140, and in Step S312 the driver 165 of the computer device 160 obtains the HDA data D2 of the storage device 120. Finally, in Step S314, the driver 165 of the computer device 160 converts the HDA data into the MIDI data MIDI-2. Thus, the content or the command of the MIDI input signal can be inputted to the computer device 160 correspondingly. For example, if a user inputs the note “Do” in the MIDI device 140, namely, the content or the command of the MIDI input signal is to play the note “Do”, the computer device 160 can generate the MIDI data MIDI-2 representing the note “Do” or an audio output of the note “Do” according to the process described above. It should be noted that the content may include a variety of durations, frequencies, and tones of sounds, which may be similarly carried out by the process described above.

As described above, the present invention uses the transmission in the command format to perform the transmission of the MIDI data via the HDA controller in one embodiment. Thus, the transmission format of the HDA data D1, the HDA data D2, and the unsolicited response signal is the command format.

In another embodiment of the present invention, the MIDI command can be transmitted by using the stream format of HDA. As described above, the stream format has a fixed data transmission rate, but the MIDI data does not have a fixed data transmission rate. Therefore, one of the stream formats supported by the HDA interface can be selected to satisfy the maximum data rate of the lowest fixed rate format of the MIDI in order to reduce the processing burden of the entire system. When MIDI data is transmitted in the stream field 1820 in a frame, the command/response field 1810 of the frame may contain other data or nulls.

After the MIDI service endpoint of the driver receives the MIDI command, the driver can insert the MIDI command in the stream format according to the fixed rate and transmit the stream format to the CODEC device 100 via the HDA controller 150. The converter 110 of CODEC device 100 obtains the MIDI command from the stream format, stores the MIDI command in the storage device 120, and transmits the MIDI command to the MIDI device 140 via the MIDI. If the driver does not receive a MIDI command within a unit period under the fixed rate, the driver will insert nulls or meaningless data into the stream format. If the converter 110 of the CODEC device 100 obtains nulls or meaningless data, no further operation will be performed.

On the other hand, when the CODEC device 100 receives the MIDI command from the MIDI device 140, the MIDI command can be temporally stored in the storage device 120. Next, the converter 110 inserts the MIDI data into the stream format according to the fixed rate, and transmits the stream format to the driver 165 via the HDA controller 150. When the driver 165 receives the MIDI command in the stream format, the driver 165 transmits the MIDI command to a related application program. Similarly, if the converter 110 does not receive the MIDI command from the MIDI device 140 within a unit period under the fixed rate, the converter 110 will insert nulls or meaningless data into the stream format according to the fixed rate. If the driver 165 obtains nulls or meaningless data in the stream format, no further operation will be performed.

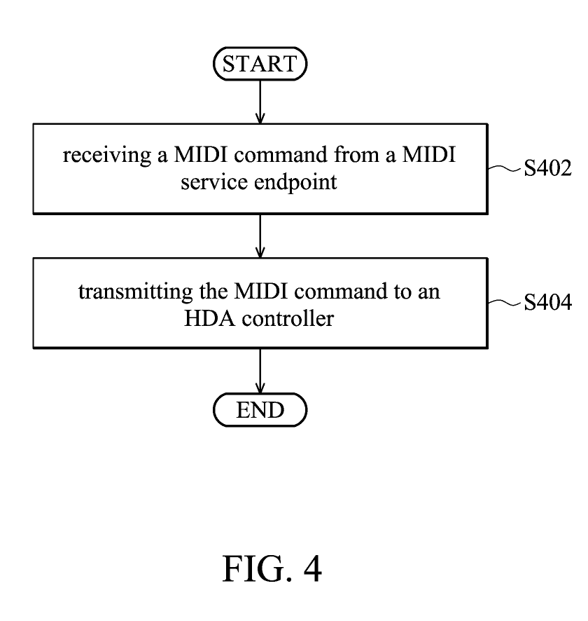

FIG. 4 is a flowchart of an embodiment of a driving method for the present invention, wherein the driving method can be applied in the driver 165 executed by the computer device 160. The driver 165 has two service endpoints, one of which is a HDA service endpoint and the other one is a MIDI service endpoint. In Step S402, the MIDI command is received from a MIDI service endpoint. Next, in Step S404, the MIDI command is transmitted to the HDA controller 150. The transmission in Step S404 can be performed in two ways. The first way of performing the transmission is to utilize the stream format of the HDA specification. The stream format is a transmission mode with a fixed data transmission rate, and the data in the stream format is null or meaningless data when the MIDI command has not been received within a unit period under the fixed rate. The second way of performing the transmission is to utilize the command format of the HDA specification, and the command format is a transmission mode with an unfixed data transmission rate.

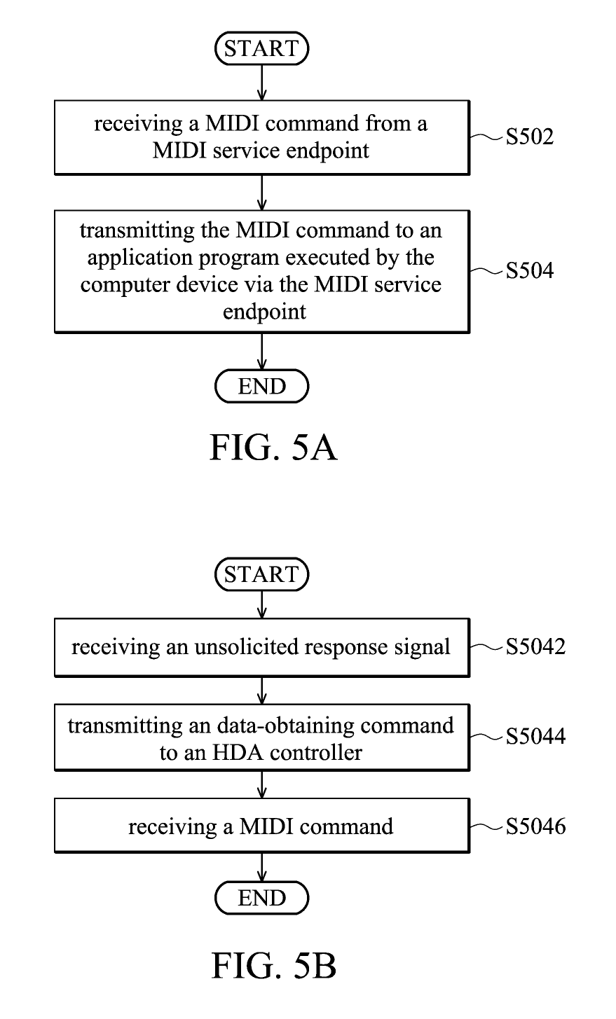

FIG. 5A is a flowchart of an embodiment of a driving method for the present invention, wherein the driving method can be applied in the driver 165 executed by the computer device 160. The driver 165 has two service endpoints, one of which is a HDA service endpoint and the other one is a MIDI service endpoint. In Step S502, the MIDI command is received from the HDA controller 150. Next, in Step S504, the MIDI command is transmitted to an application program of computer device 160 via the MIDI service endpoint. The transmission of Step S502 can be performed in two ways. The first way of performing transmission is to utilize the stream format of the HDA specification. The stream format is a transmission mode with a fixed data transmission rate, and Step S504 is not performed when the received data in the stream format is null or meaningless data. In the second way of performing the transmission, Step S504 can further comprise steps S5042, S5044 and S5046 as shown in FIG. 5B. In Step S5042, an unsolicited response signal is received. Next, in Step S5044 a data-obtaining command is transmitted to the HDA controller 150. Finally, in the Step S5046 the MIDI command is received.

While the invention has been described by ways of examples and in terms of preferred embodiments, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A coding and decoding (CODEC) device, comprising:
a first interface, compatible with a High Definition Audio (HDA) specification;
a second interface, compatible with a Musical Instrument Digital Interface (MIDI) specification; and
a converter, converting a first MIDI command received from the first interface and outputting a corresponding first converted MIDI command via the second interface, and converting a second MIDI command received from the second interface and outputting a corresponding second converted MIDI command via the first interface.

2. The CODEC device of claim 1, wherein the first MIDI command and the second converted MIDI command is in a stream format of the HDA specification, wherein the stream format has a fixed data transmission rate.

3. The CODEC device of claim 2, wherein the first MIDI command comprises null or meaningless data when a driver of a computer device does not receive a corresponding MIDI command within a transmission period.

4. The CODEC device of claim 2, wherein the second converted MIDI command comprises null or meaningless data when the converter does not receive the second MIDI command within a transmission period.

5. The CODEC device of claim 1, wherein the first MIDI command and the second converted MIDI command is in a command format of the HDA specification, wherein the command format has an unfixed data transmission rate.

6. The CODEC device of claim 5, wherein an unsolicited response signal is transmitted to the first interface before the converter converts the second MIDI command.

7. The CODEC device of claim 5, wherein the converter transmits the second converted MIDI command to the first interface after a data-obtaining command is received from the first interface.

8. The CODEC device of claim 5, wherein the converter receives a plurality of second MIDI commands before an unsolicited response signal is transmitted to the first interface.

9. The CODEC device of claim 1, further comprising:
a control unit, generating an unsolicited response signal with a special tag to indicate that a MIDI command is stored in the CODEC device.

10. A method for a CODEC device, comprising:
receiving a first MIDI command from a first interface, wherein the first interface is compatible with the HDA specification;
converting the first MIDI command; and
outputting a corresponding first converted MIDI command via a second interface to a MIDI device, wherein the second interface is compatible with a MIDI specification.

11. The method of claim 10, wherein the first MIDI command is in a stream format of the HDA specification, wherein the stream format has a fixed data transmission rate.

12. The method of claim 11, wherein the first MIDI command comprises null or meaningless data when a driver of a computer device does not receive a corresponding MIDI command within a transmission period.

13. The method of claim 10, wherein the first MIDI command is in a command format of the HDA specification, wherein the command format has an unfixed transmission rate.

14. A method for a CODEC device, comprising:
receiving a second MIDI command from a second interface, wherein the second interface is compatible with a MIDI specification;
converting the second MIDI command; and
outputting a corresponding second converted MIDI command via a first interface, wherein the first interface is compatible with a HDA specification.

15. The method of claim 14, wherein the second converted MIDI command is in a stream format of the HDA specification, wherein the stream format has a fixed transmission rate.

16. The method of claim 15, further comprising:
outputting the second converted MIDI command comprising null or meaningless data when the second MIDI command is not received within a transmission period.

17. The method of claim 14, wherein the second converted MIDI command is in a command format of the HDA specification, wherein the command format has an unfixed data transmission rate.

18. The method of claim 14, further comprising:
transmitting an unsolicited response signal to the first interface before converting the second MIDI command.

19. The method of claim 14, further comprising:
transmitting the second converted MIDI command to the first interface after receiving a data-obtaining command from the first interface.

20. The method of claim 18, wherein a plurality of second MIDI commands are received before transmitting the unsolicited response signal to the first interface.
